(19) United States
(12) Patent Application Publication
(10) Pub. No.: US 2014/0149350 A1
(43) Pub. Date: May 29, 2014

(54) Remote Replication in a Storage System

(71) Applicant: International Business Machines Corporation, Armonk, NY (US)

(72) Inventors: Chen Chen, Shanghai (CN); Dang Fang, Shanghai (CN); Lin Xu, Shanghai (CN)

(73) Assignee: International Business Machines Corporation, Armonk, NY (US)

(21) Appl. No.: 14/076,504

(22) Filed: Nov. 11, 2013

(30) Foreign Application Priority Data
Nov. 27, 2012 (CN) 201210490840.1

(51) Int. Cl. G06F 17/30

(52) U.S. Cl. CPC G06F 17/30575
USPC 707/634

(57) ABSTRACT

A mechanism is provided for performing a semi-synchronization remote replication from a local device to a remote device in a storage system. After establishing a remote replication association between the local device and the remote device, the mechanism measures a real-time available bandwidth of a network path corresponding to the remote replication association from the local device to the remote device. A transmission rate for the local device to perform the remote replication is determined based on the measured real-time available bandwidth.

### BACKGROUND

The present invention relates to remote replication in a storage system, and more specifically, to a method and device for semi-synchronous remote replication in a storage system.

Among clustered storage systems, many of them provide synchronous/asynchronous remote replication features for customer solutions (for example, for Disaster Recovery solution). Synchronous remote replication is highly demanding on write delay and network bandwidth, while asynchronous remote replication cannot guarantee exact consistency between a secondary copy and a primary copy. A higher or lower Recovery Point Objective is dependent on the network bandwidth. Nowadays, storage products with a semi-synchronous remote replication capability have been provided.

FIG. 1 schematically shows a storage system 100 implementing semi-synchronous remote replication. In the storage system 100, a local device 110 as a primary site supports input/output (I/O) operations as performed by an application of a client device for the local device; a remote device 120 as a remote site establishes a remote replication storage relationship with the primary site. Under a system scheme of a semi-synchronous remote replication, the I/O operations of the application are simultaneously transmitted to the local device 110 as the primary storage (step 1 I/O operations) and sent from the local device 110 as the primary storage to the remote device 120 as the secondary storage (step 2′ foreground replication process). However, such a possibility exists: before the I/O operations were actually replicated to the remote device 120 as the secondary storage to form a duplicated copy, the application already receives an indication that the primary site has accomplished I/O operations at (step 3 the primary site accomplishes the I/O operation), and then it is deemed that the whole storage process has been accomplished. However, in fact, the remote replication process to the remote device 120 as the secondary storage cannot be completed due to some reason (step 3′ foreground replication overtime). As above mentioned, whether the remote replication can be accomplished depends on the network bandwidth, i.e., the bandwidth capacity of the communication path between the local device 110 and the remote device 120 for remote replication.

Specifically, after the remote replication relationship between the local device 110 and the remote device 120 is established, i.e., after the background replication is established, the storage system 100 uses a certain copy rate/bandwidth from among the link capacity for inter-cluster remote replication, often known as foreground copy rate, to maintain inter-cluster synchronization. This replication rate/bandwidth is usually a system default value or a predefined value in the prior art. This replication process propagates changes in data on the local device 110 as the primary storage to a remote device 120 as the secondary storage so as to maintain synchronization therebetween. However, in some real client scenarios, the storage system cannot provide a stable link bandwidth, for example, low-bandwidth bottleneck exists in the communication path between the local device 110 and the remote device 120. At this point, if the load of the foreground replication process is much higher than the actual link bandwidth, the communication path will be overloaded. In response to occurrence of such scenario, existing semi-synchronous remote replication storage systems usually automatically stop remote replication when system performance is degraded to a threshold, for example, the system default value or a user-customized value; therefore, the remote replication relationship between the local device 110 and the remote device 120 is interrupted.

Under the existing schemes, the system will issue an error alarm to notify the user so as to avoid the user's application from suffering degraded performance introduced by degraded link between the local and remote replication systems. Since the remote replication relationship between the local and remote replication systems has been interrupted, the user has to manually restart the remote replication (step 2 submit a change), which will cause extra burden to the user. The unavoidable user intervention may be very troublesome to a user/administrator.

However, the prior art fails to provide a solution to resolve the above technical problems.

### SUMMARY

In order to resolve the above problems in the prior art, embodiments of the present invention provide an adaptive remote replication method, which may provide a robust remote replication in the case of network bandwidth limitation and fluctuation and can avoid suspension of remote replication and extra intervention from the user.

According to one aspect of the present invention, there is provided a method for performing remote replication from a local device to a remote device in a storage system, comprising: after establishing a remote replication association between the local device and the remote device, measuring a real-time available bandwidth of a network path corresponding to the remote replication association from the local device to the remote device: and determining a transmission rate for the local device to perform the remote replication based on the measured real-time available bandwidth.

In other illustrative embodiments, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

In yet another illustrative embodiment, a computer program product comprising a computer useable or readable medium having a computer readable program is provided. The computer readable program, when executed on a computing device, causes the computing device to perform various ones of, and combinations of, the operations outlined above with regard to the method illustrative embodiment

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows an exemplary storage system for implementing remote replication;

FIG. 2 shows a block diagram of an exemplary computer system/server 12 adapted to implementing the embodiments of the present invention;

FIG. 3 shows a flow chart diagram of a method for performing remote replication from a local device to a remote device in a storage system;

FIG. 4 shows an exemplary diagram of a static bandwidth measurement scheme according to one embodiment of the present invention;

FIG. 5 shows an exemplary diagram of a dynamic bandwidth measurement scheme according to one embodiment of the present invention; and

FIG. 6 shows a block diagram of a device used in a storage system according to one embodiment of the present invention.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, device, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, device, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, device, or device.

Program code embodied on a computer readable medium may be transmitted using any appropriate medium, including but not limited to wireless, wireline, optical fiber cable, RF, etc., or any suitable combination of the foregoing.

Computer program code for performing operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, device (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks.

These computer program instructions may also be stored in a computer readable medium that can direct a computer, other programmable data processing device, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing device, or other devices to cause a series of operational steps to be performed on the computer, other programmable device or other devices to produce a computer implemented process such that the instructions which execute on the computer or other programmable device provide processes for implementing the functions/acts specified in the flowchart and/or block diagram block or blocks.

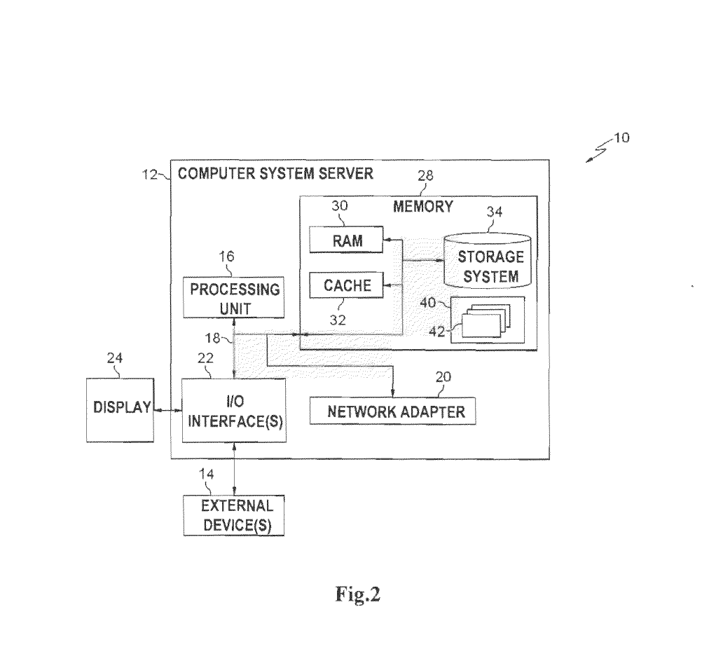

Referring now to FIG. 2, in which an exemplary computer system/server 12 of a larger data processing system 10 which is applicable to implement the embodiments of the present invention is shown. Computer system/server 12 is only illustrative and is not intended to suggest any limitation as to the scope of use or functionality of embodiments of the invention described herein.

As shown in FIG. 2, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to perform the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally perform the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12, and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

According to the embodiments of the present invention, there is provided an adaptive remote replication solution to resolve the problems existing in the prior art. Mainly, the embodiments of the present invention introduce a bandwidth measurement mechanism and a transmission rate control mechanism in a remote replication solution to dynamically control the transmission rate for the remote replication, thereby providing a robust remote replication in the case of network bandwidth limitation and fluctuation and being capable of avoiding suspension of remote replication and extra intervention from a user. According to one or more embodiments of the present invention, a local device (for example, the local device 110) as a primary site may preferably obtain a bandwidth capacity in a very short time prior to processing a data replication request during an initial stage; and continuously monitor a real-time available bandwidth of a path being used by a replication process prior to start of the replication process during an operating stage, thereby obtaining changes in an available bandwidth. Therefore, the local device as a primary site may adaptively adjust the transmission rate for the remote replication based on the measured bandwidth.

The term “background replication” mentioned above refers to the process of replicating the already existing original data on the local device to a remote device and forming an original data copy after a remote replication association is established between a local device and a remote device; and “foreground replication” refers to a process of replicating data modifications submitted by the local device to the remote device and forming a modified copy, after a remote replication association between the local device and the remote device is established and the remote device already has the original data copy. Unless otherwise indicated, use of the above terms hereinafter means at least citing the above technical meanings of the corresponding terms.

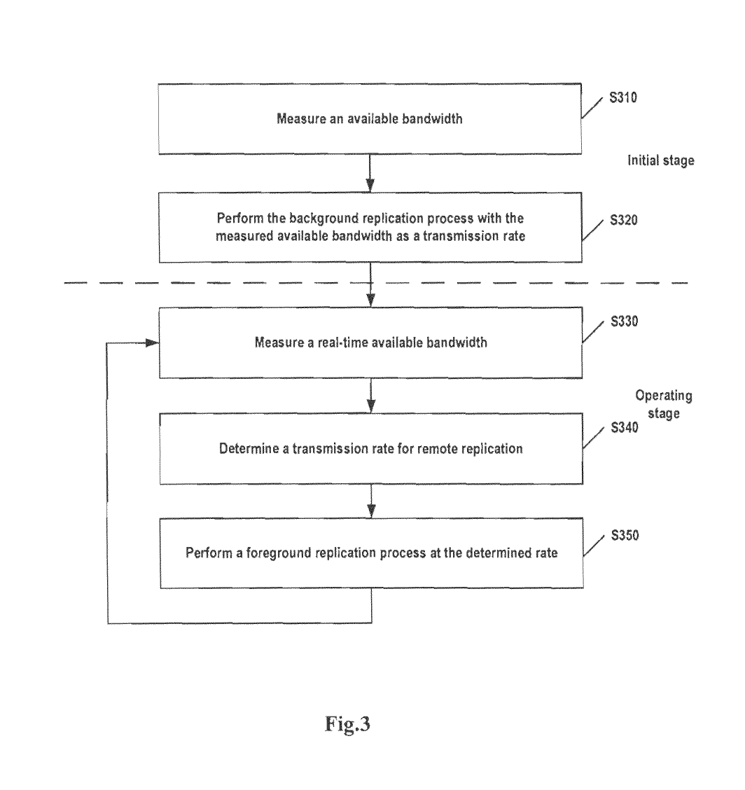

Now, refer to FIG. 3. FIG. 3 shows a flow chart of a method for performing remote replication from a local device to a remote device in a storage system according to the embodiments of the present invention.

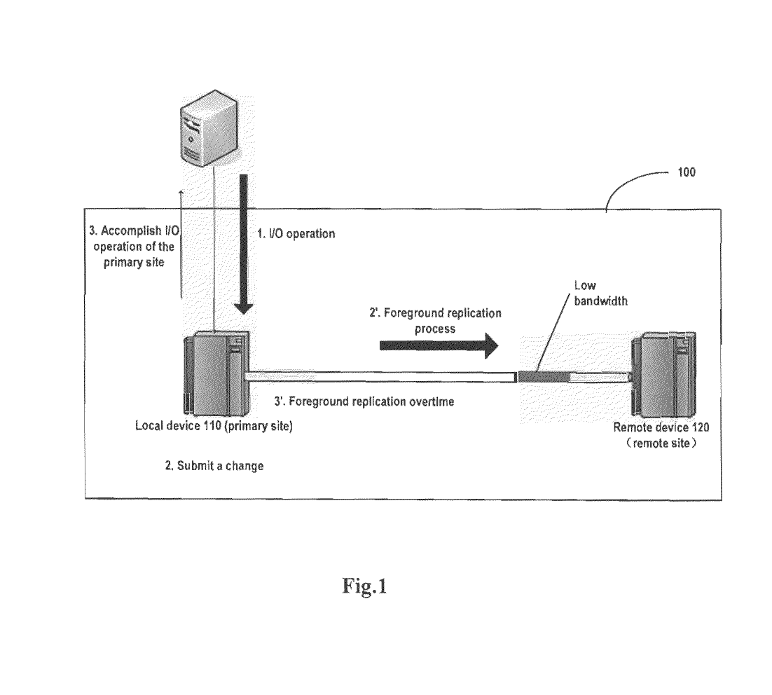

The flow of the remote replication method as shown in FIG. 3 may be divided into two stages, i.e., an initial stage and an operating stage. During the initial stage, for example, as shown in FIG. 1, the storage system 100 for implementing a semi-synchronous remote replication needs to establish a remote replication association between a local device and a remote device and perform a background replication process; while in the operating stage, for example, as shown in FIG. 1, the storage system 100 for implementing a semi-synchronous remote replication needs to initiate a remote replication process in response to data I/O operation in the local device 110 to thereby perform a foreground replication process.

According to one embodiment of the present invention, during the initial stage, in step S310, an available bandwidth of a network path between the local device and the remote device is measured prior to establishing the remote replication association between the local device and the remote device, so as to establish the remote replication association.

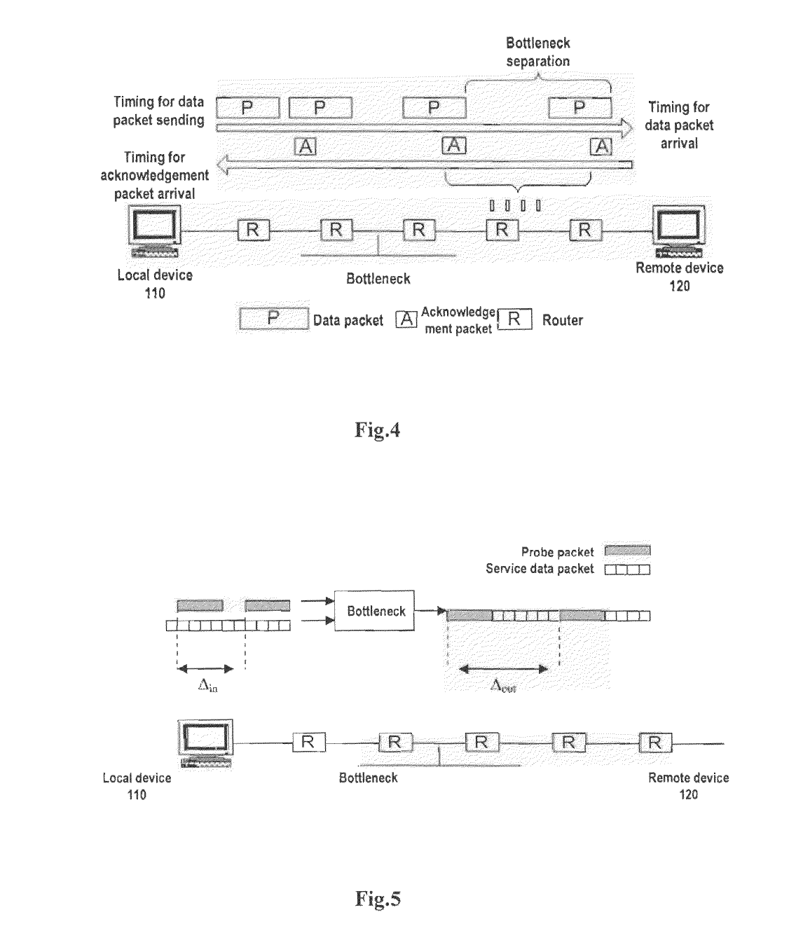

In one embodiment, a process using a static bandwidth measurement may be run prior to start of the remote replication process so as to obtain the capacity of the network path for background remote replication. Any appropriate static bandwidth measurement schemes may be adopted to perform the above measuring step. A specific example of the static bandwidth measurement scheme will be described hereinafter with reference to FIG. 4.

In step S320, the measured available bandwidth is used as the transmission rate for remote replication so as to perform the background replication process from the local device to the remote device.

Those skilled in the art would understand that during the initial stage, the storage system preferably may perform bandwidth measurement and all the measured available bandwidth can be used for the background replication process, thereby improving the performance of the background replication process. However, since the process is merely executed during the initial stage, the storage system may select not to perform the bandwidth measurement; instead, the background replication process is performed independent of an initial transmission rate of the measured bandwidth, and various inventive features of the present invention are implemented merely dependent on the subsequent working process to achieve improvement of the system performance. Thus, those skilled in the art would appreciate that steps S310 and S320 are preferable, to the technical solution of the present invention.

If measurement of the available bandwidth as in step S310 is performed in the initial stage, alternatively according to one embodiment of the present invention, a transmission rate lower than the available bandwidth measured in step S320 by a certain threshold or percentage may act as the transmission rate for remote replication during the operating stage so as to initiate the initial foreground replication process. Of course, if the measurement of available bandwidth for example in step S310 is not performed in the initial stage, then the initial foreground replication process may be initiated with an initial transmission rate as set, or the initial foreground replication process may also be performed according to the procedures described in steps S330-S350, like the subsequent foreground replication process.

In step S330, after the remote replication association between the local device and the remote device is established, a real-time available bandwidth of a network path corresponding to the remote replication association from the local device to the remote device is obtained.

In one embodiment, the local device may run a process adopting a dynamic bandwidth measurement scheme to real-time monitor the fluctuation of the available bandwidth on the network path corresponding to the remote replication association between the local device and the remote device, so as to obtain the real-time available bandwidth of the network path corresponding to the remote replication association from the local device to the remote device. For example, the information about the bandwidth change trend may be obtained, and one or more monitoring results of the available bandwidth may be used to estimate a level of the real-time available bandwidth. Any appropriate dynamic bandwidth measurement schemes may be adopted to implement the above measurement steps. A specific example of a dynamic bandwidth measurement scheme will be described hereinafter with reference to FIG. 5.

In another embodiment, measurement of the real-time available bandwidth of the network path corresponding to the replication association may also be initiated by the remote device, which then reports the measurement result to the local device. The local device receives the report from the remote device, thereby obtaining the real-time available bandwidth of a network path corresponding to the remote replication association from the local device to the remote device.

In step S340, a transmission rate for the local device to perform the remote replication is determined based on the measured real-time available bandwidth.

The obtained real-time available bandwidth (or estimation value of the real-time available bandwidth) provides a basis for controlling the transmission rate of the remote replication. Those skilled in the art may select a specific control policy so as to guarantee that the transmission rate of the remote replication is adapted to the measured real-time available bandwidths, thereby avoiding compulsory suspension of the remote replication.

According to one embodiment of the present invention, the transmission rate for performing the remote replication may be determined as a value lower than the real-time available bandwidth as measured in step S330 or the real-time available bandwidth estimation value. For example, the transmission rate for remote replication may be determined as lower than the real-time available bandwidth as measured in step S330 or the real-time available bandwidth estimation value by a predetermined gap threshold or percentage. Here, the gap threshold or percentage may be called a reserved bandwidth threshold or a reserved bandwidth percentage. Those skilled in the art would appreciate that the reserved bandwidth threshold or the reserved bandwidth percentage may be set as a relatively small value. For example, the reserved Bandwidth Threshold may be set to any fixed value larger than zero but equal to or smaller than 10% of the network path bandwidth B as initially measured. For another example, the reserved bandwidth percentage may be set to any fixed value larger than zero but equal to or smaller than 10%. Such a control policy enables the data transmission rate for performing the remote foreground replication process to be slightly lower than the measured real-time available bandwidth and to adaptively change with the real-time available bandwidth.

Such control policy at least has the following advantageous effects. In the one hand, the reserved bandwidth threshold or the reserved bandwidth percentage may prevent the foreground replication process from exhausting the entire bandwidth resources, and the reserved bandwidth may be used to transmit other data between clustered systems, for example, probe data for performing the available bandwidth measurement. On the other hand, the Reserved Bandwidth Threshold or the Reserved Bandwidth Percentage may also control the rate of the foreground replication process of the remote replication, such that the rate of the foreground replication process can adaptively change with the measured real-time available bandwidth.

For example, in one embodiment, after the remote replication process is established during the operating stage, the local device will regularly perform bandwidth measurement or receive the bandwidth measurement from the remote device so as to dynamically obtain the available bandwidth. Each time when the available bandwidth is updated, the local device will dynamically control execution of the transmission rate policy during the foreground replication process in the following ways:
in the case of obtaining that the real-time available bandwidth decreases, it is controlled to lower the transmission rate of the foreground replication process, such that the transmission rate of the foreground replication process is lower than the measured real-time available bandwidth by a predetermined threshold or percentage;
in the case of obtaining that the real-time available bandwidth increases, it is controlled to increase the transmission rate of the foreground replication process, such that the transmission rate of the foreground replication process is lower than the measured real-time available bandwidth by a predetermined threshold or percentage.

In step S350, the foreground replication process is performed from the local device to the remote device with the determined transmission rate.

The flowchart of a method for performing remote replication from a local device to a remote device in a storage system according to the embodiments of the present invention has been described above with reference to FIG. 3. The bandwidth measuring steps S310 and S330 involved in FIG. 3 may be implemented by any appropriate bandwidth measurement method in the art without departing from the essence of the present invention. Since the remote replication association between the local device and the remote device has not been established yet during the initial stage, the measurement step S310 may be performed by a static bandwidth measurement method which occupies more transmission width but a higher accuracy; moreover, since the remote replication association between the local device and the remote device has been established during the operating stage, the transmission bandwidth is mainly used for performing the foreground replication process, and therefore in S330, the measurement performed by the local device or remote device may use a dynamic bandwidth scheme which occupies less transmission bandwidth but a slightly lower accuracy. Hereinafter, the implementation schemes of the measurement processes in steps S310 and S330 will be described in detail with reference to FIGS. 4 and 5.

FIG. 4 shows an exemplary diagram of a static bandwidth measurement scheme according to one embodiment of the present invention, wherein a preferable static bandwidth measurement scheme is illustrated: estimating an available bandwidth through a Packet Pair algorithm.

As shown in FIG. 4, the local device 110 continuously sends two identical-sized probe packets to the remote device 120 without intervals. The two probe packets go through all network links between the local device 110 and the remote device 120. When the two probe packets go through a link with a bottleneck, a time interval will be generated between the two probe packets. After receiving the two probe packets, the remote device 120 will return two independent acknowledgement packets with timestamps. The local device 110 receives the two acknowledgement packets and calculates the available bandwidth B with the following equation:

$$B = \frac{L}{{T}_{Δ}}$$

wherein B denotes the derived available bandwidth, L denotes the size of a probe packet, T_{Δ} denotes a gap between arrival times of the two probes at the local device 110.

It should be noted that because noise always exists between communication links, it would be advantageous to obtain an available bandwidth estimation value by using multiple times of measurement samples so as to obtain a more accurate result.

Here, as an example, a filter algorithm is applied to generate an estimation value of the available bandwidth, wherein a kernel density estimation algorithm may be used to filter samples so as to computer the available bandwidth estimation value.

Of course, other manners may also be used to obtain the available bandwidth estimation value, including, but not limited to, using an arithmetic average value, a geometric average value, and a weighted average value, etc., for measuring the available bandwidth for multiple times.

As an alternative, the variable packet size probe (VPSP) algorithm may also be used to measure the static available bandwidth of the network link. The variable packet size probe is dependent on the variable packet size. In this algorithm, the local device 110 sends a series of different sized packets. The remote device 120 obtains these packets and sends an acknowledgement packet to the local device 110. In the case of different packet sizes, the local device 110 calculates the time interval between sending the packets and receiving the acknowledgement packet, and works out the available bandwidth. In this solution, multiple times of measurement samples may be used to obtain the available bandwidth estimation value.

Although the available bandwidth estimation on the algorithm has been described in detail through the data packets and another alternative solution of performing available bandwidth estimation through the variable packet size probe algorithm has been introduced with reference to FIG. 4, those skilled in the art should understand that the static bandwidth measurement scheme as described here is merely exemplary, not intended to exhaust all measurement schemes capable of being applied to the technical solution of the present invention in the art. Those skilled in the art can adopt any appropriate measurement schemes or a combination of the measurement schemes to implement the static measurement of available bandwidth according to actual demands and system requirements.

FIG. 5 shows an exemplary diagram of a dynamic bandwidth measurement scheme according to one embodiment of the present invention, which shows a preferable dynamic bandwidth measurement scheme: performing real-time available bandwidth estimation through a Probe Gap Model (PGM).

As shown in FIG. 5, the dynamic bandwidth measurement uses the Probe Gap Model (PGM) to measure the real-time available bandwidth. The Probe Gap Model algorithm uses the time interval information between arrivals of the two consecutive probe packets at the remote device 120. The local device 110 sends a Probe Packet Pair with a time interval Δᵢₙ, while the arrive time interval of the Probe Packet Pair received by the remote device 120 is Δₒᵤₜ. Suppose a single bottleneck exists in the network path between the local device 110 and the remote device 120, and the queue of the bottleneck in the interval between leaving of the first probe packet and arrive of the second probe packet is not empty, then Δₒᵤₜ refers to the time required for bottleneck transmitting the second probe packet or other traffic arriving at the bottleneck within Δₘ interval, as shown in FIG. 5. The local device 110 may calculate the real-time available bandwidth A with the following equation:

$$A = C \times ( 1 - \frac{{Δ}_{out} - {Δ}_{in}}{{Δ}_{in}} )$$

where C denotes the capacity of the bottleneck link.

During the process of performing foreground remote replication in the operating stage, the probe packet is transmitted between the data packets at a rate of 0.2%-0.5% of the bandwidth capacity. This sampling rate may guarantee that the bandwidth measurement process will not affect the transmission rate of a foreground replication for remote replication. On the other hand, the real-time available bandwidth as measured suffices to derive the latest change of the available bandwidth.

As an alternative, the Probe Rate Model (PRM) algorithm may also be used for measuring the dynamic real-time available bandwidth of a network link. The Probe Rate Model is based on a concept of self-induced congestion. In short, if the local device 110 sends a probe traffic at a rate being less than the path available bandwidth, the probe traffic of the remote device 120 should match the sending rate of the sender, on the contrary, if the local device 110 sends a probe traffic at a rate higher than the available bandwidth, a queue will be established inside the network, and the probe traffic will delay. As a result, the probe rate at the remote device 120 will be lower than the sending rate of the sender. Thus, by searching a changing point at which the probe traffic sending rate and the receiving rate begins to match, the real-time available bandwidth may be measured.

Here, although real-time available bandwidth estimation performed through a Probe Gap Model has been described in detail with reference to FIG. 5 and another alternative solution for performing the real-time available bandwidth estimation with the Probe Rate Model algorithm has been introduced, those skilled in the art should understand that the dynamic bandwidth measurement scheme as described here is merely exemplary, not intended to exhausting all measurement schemes applicable to the technical solution of the present invention in the present field. Those skilled in the art can adopt any appropriate measurement schemes or combination of measurement schemes to realize dynamic measurement of real-time available bandwidths.

Only the local device as a measurement process initiator is taken as an example in the above description of FIG. 5, and when the remote device initiates the measurement process, the measurement of available bandwidths may be likewise implemented with reference to the above discussed algorithm.

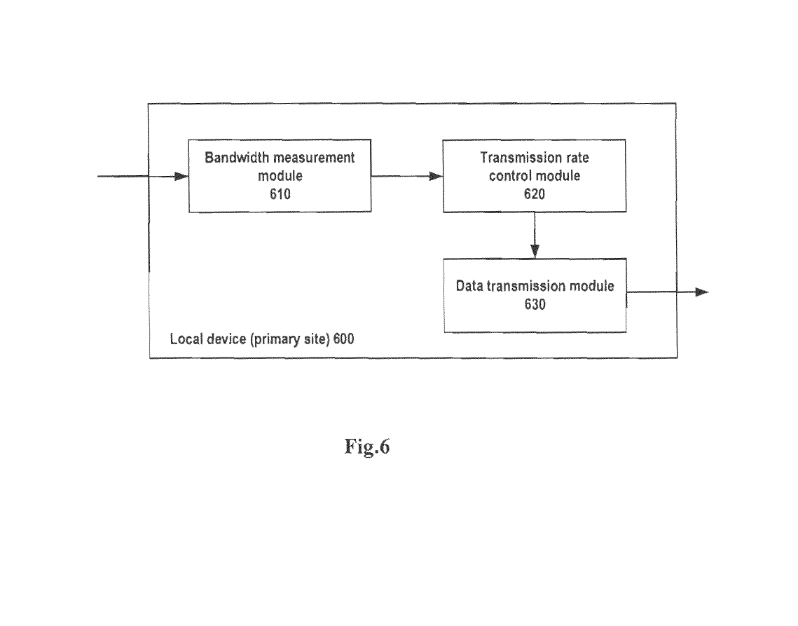

FIG. 6 shows a block diagram of a device applicable in a storage system according to one embodiment of the present invention.

As shown in FIG. 6, the device 600 applicable in a storage system according to one embodiment of the present invention is configured to perform remote replication from the device 600 to a remote device n the storage system. The device 600 for example is a local device serving as a primary device in the storage system. The local device 600 comprises: a bandwidth measurement module 610 and a rate control module 620, wherein the bandwidth measurement module 610 is configured to obtain, after a remote replication association is established between the local device 600 and the remote device, a real-time available bandwidth of a network path corresponding to the remote replication association from the local device 600 to the remote device; and the transmission rate control module 620 is configured to determine a transmission rate for the local device 600 to perform the remote replication based on the measured real-time available bandwidth.

According to one embodiment of the present invention, the local device 600 may further comprise a data transmission module 630 configured to perform a foreground replication process from the local device 600 to the remote device at the determined transmission rate.

According to one embodiment of the present invention, the bandwidth measurement module 610 is further configured to measure an available bandwidth of a network path between the local device 600 and the remote device prior to establishing a remote replication association between the local device 600 and the remote device. Further, the transmission rate control module 620 is configured to determine the transmission rate for remote replication to be the measured available bandwidth, and the data transmission module 630 is configured to perform a background replication process from the local device 600 to the remote device at the determined transmission rate.

According to one embodiment, the transmission rate control module 620 is further configured to determine the transmission rate for remote replication to be a value lower than the measured available bandwidth, and the data transmission module 630 is configured to initiate the initial foreground replication process at the determined transmission rate.

According to one embodiment, the transmission rate control module 620 is configured to determine the transmission rate for remote replication by determining the transmission rate to be a value lower than the measured real-time available bandwidth. And the data transmission module 630 is configured to perform an initial foreground replication process from the local device 600 to the remote device at the determined transmission rate.

According to one embodiment of the present invention, the bandwidth measurement module 610 is configured to obtain, after establishing a remote replication association between the local device 600 and the remote device, a real-time available bandwidth of a network path corresponding to the remote replication association from the local device 600 to the remote device, by adopting a dynamic bandwidth measurement scheme. For example, the dynamic bandwidth measurement scheme includes at least one selected from a group including Probe Gap Model algorithm, Probe Rate Model algorithm.

According to the embodiments of the present invention, the bandwidth measurement module 610 is configured to measure, prior to establishing a remote replication association between a local device 600 and a remote device, an available bandwidth of a network path between the local device 600 and a remote device, by adopting a static bandwidth measurement scheme. For example, the static bandwidth measurement scheme comprises at least one selected from a group including: Packet Pair Algorithm Variable Packet Size Probe Algorithm.

The device 600 for example may be implemented as a computer system as shown in FIG. 2, wherein the functionalities of respective components may be implemented through the functions of respective components of the computer system as shown in FIG. 2 or through the combination of the functions of respective components.

According to another aspect of the present invention, there is further provided a corresponding computer program product with existing computer program code being embodied thereon, wherein the computer program code is configured to have, together with at least one processor of a device 600, the device 600 at least execute a computer instruction to control the above respective components of the device 600 to perform their corresponding functions.

According to various embodiments of the present invention, the transmission rate for performing remote replication can be controlled dynamically by introducing the bandwidth measurement scheme and transmission rate control scheme, thereby achieving robustness of the remote replication in the case of network bandwidth limitation and fluctuation and avoiding suspension of remote replication and extra intervention from the user.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for performing remote replication from a local device to a remote device in a storage system, comprising:
measuring, after establishing a remote replication association between the local device and the remote device, a real-time available bandwidth of a network path corresponding to the remote replication association from the local device to the remote device; and
determining a transmission rate for the local device to perform the remote replication based on the measured real-time available bandwidth.

2. The method according to claim 1, further comprising:
performing a foreground replication process from the local device to the remote device at the determined transmission rate.

3. The method according to claim 1, further comprising:
measuring, prior to establishing a remote replication association between the local device and the remote device, an available bandwidth of the network path between the local device and the remote device, so as to establish the remote replication association; and
performing a background replication process from the local device to the remote device with the measured available bandwidth as the transmission rate for the remote replication.

4. The method according to claim 3, further comprising:
initiating an initial foreground replication process with a transmission rate lower than the measured available bandwidth as the transmission rate for the remote replication.

5. The method according to claim 1, wherein determining the transmission rate for the local device to perform the remote replication based on the measured real-time available bandwidth comprises:
determining the transmission rate to be a value lower than the measured real-time available bandwidth.

6. The method according to claim 1, wherein measuring, after establishing the remote replication association between the local device and the remote device, the real-time available bandwidth of the network path corresponding to the remote replication association from the local device to the remote device is implemented using a dynamic bandwidth measurement scheme.

7. The method according to claim 6, wherein the dynamic bandwidth measurement scheme comprises at least one of:
a probe gap model algorithm; or
a probe rate model algorithm.

8. The method according to claim 3, wherein measuring, prior to establishing the remote replication association between the local device and the remote device, the available bandwidth of the network path between the local device and the remote device, so as to establish the remote replication association is implemented with a static bandwidth measurement scheme.

9. The method according to claim 8, wherein the static bandwidth measurement scheme comprises at least one of:
a packet pair algorithm; or
a variable packet size probe algorithm.

10-18. (canceled)

19. An apparatus for performing remote replication from a local device to a remote device in a storage system, comprising:
a processor; and
a memory coupled to the processor, wherein the memory comprises instructions which, when executed by the processor, cause the processor to:
measure, after establishing a remote replication association between the local device and the remote device, a real-time available bandwidth of a network path corresponding to the remote replication association from the local device to the remote device; and
determine a transmission rate for the local device to perform the remote replication based on the measured real-time available bandwidth.

20. (canceled)

21. The apparatus according to claim 19, wherein the instructions further cause the processor to:
perform a foreground replication process from the local device to the remote device at the determined transmission rate.

22. The apparatus according to claim 19, wherein the instructions further cause the processor to:
measure, prior to establishing a remote replication association between the local device and the remote device, an available bandwidth of the network path between the local device and the remote device, so as to establish the remote replication association; and
perform a background replication process from the local device to the remote device with the measured available bandwidth as the transmission rate for the remote replication.

23. The apparatus according to claim 22, wherein the instructions further cause the processor to:
initiate an initial foreground replication process with a transmission rate lower than the measured available bandwidth as the transmission rate for the remote replication.

24. The apparatus according to claim 19, wherein the instructions to determine the transmission rate for the local device to perform the remote replication based on the measured real-time available bandwidth further causes the processor to:
determine the transmission rate to be a value lower than the measured real-time available bandwidth.

25. The apparatus according to claim 19, wherein the instructions to measure, after establishing the remote replication association between the local device and the remote device, the real-time available bandwidth of the network path corresponding to the remote replication association from the local device to the remote device is implemented using a dynamic bandwidth measurement scheme.

26. The apparatus according to claim 25, wherein the dynamic bandwidth measurement scheme comprises at least one of:
a probe gap model algorithm; or
a probe rate model algorithm.

27. The apparatus according to claim 22, wherein the instructions to measure, prior to establishing the remote replication association between the local device and the remote device, the available bandwidth of the network path between the local device and the remote device, so as to establish the remote replication association is implemented with a static bandwidth measurement scheme.

28. The apparatus according to claim 27, wherein the static bandwidth measurement scheme comprises at least one of:
a packet pair algorithm; or
a variable packet size probe algorithm.

29. A computer program product comprising a computer readable storage medium having a computer readable program stored therein, wherein the computer readable program, when executed on a computing device, causes the computing device to:
measure, after establishing a remote replication association between the local device and the remote device, a real-time available bandwidth of a network path corresponding to the remote replication association from the local device to the remote device; and
determine a transmission rate for the local device to perform the remote replication based on the measured real-time available bandwidth.

30. The computer program product according to claim 29, wherein the computer readable program further causes the computing device to:
perform a foreground replication process from the local device to the remote device at the determined transmission rate.
